(19) United States
(12) Patent Application Publication
(10) Pub. No.: US 2016/0360557 A1
(43) Pub. Date: Dec. 8, 2016

(54) COLLABORATIVE MPTCP

(71) Applicants: GM GLOBAL TECHNOLOGY OPERATIONS LLC, Detroit, MI (US); Tel Aviv Yaffo College, Tel Aviv-Yafo (IS)

(72) Inventors: Nadav Lavi, RAMAT-HASHARON (IL); MOSHE LAIFENFELD, HAIFA (IL); KOBI JACOB SCHEIM, PARDESS HANNA (IL); OSNAT MOKRYN, HAIFA (IL); RAM PLISKIN, RISHON LEZION (IL); MAOR BIN, AFULA (IL); Eilon Riess, Zikron Yaakov (IL)

(21) Appl. No.: 15/018,123

(22) Filed: Feb. 8, 2016

Related U.S. Application Data
(60) Provisional application No. 62/172,609, filed on Jun. 8, 2015.

(51) Int. Cl. H04W 76/02; H04L 29/08

(52) U.S. Cl. CPC H04W 76/02; H04L 67/10

(57) ABSTRACT

A system and method are provided for establishing a multipath connection between two endpoints. The method includes establishing a connection between a first of the two endpoints and one or more consumer devices, creating a virtual network interface in the first of the two endpoints for each of the one or more consumer devices connected to the first of the two endpoints, and transferring packets from the first of the two endpoints through each virtual network interface to a second of the two endpoints.

### TECHNICAL FIELD

The present invention relates to connecting a vehicle to the Internet, and more particularly, to enabling concurrent data streams between the vehicle and the Internet by utilizing one or more consumer devices.

### BACKGROUND

Most vehicles are now equipped with hardware, such as a telematics unit, that enables a variety of wireless communications, including connecting to the Internet or Cloud. The telematics unit is able to act as a wireless access point between the vehicle infotainment system and the Internet through a wireless carrier system (e.g., a cellular network). With the onset of increased demand to stream data such as video over these connections, bandwidth availability quickly becomes limited.

### SUMMARY

According to an embodiment of the invention, there is provided a method for establishing a multipath connection between two endpoints. The method includes establishing a connection between a first of the two endpoints and one or more consumer devices, creating a virtual network interface in the first of the two endpoints for each of the one or more consumer devices connected to the first of the two endpoints, and transferring packets from the first of the two endpoints through each virtual network interface to a second of the two endpoints.

According to another aspect of the invention, there is provided a method for enabling multiple connections between a vehicle telematics unit and a server using MPTCP. The method includes establishing a connection from the vehicle telematics unit to one or more consumer devices, creating a virtual network interface in the telematics unit for each of the one or more consumer devices connected to the telematics unit, and transferring packets from the telematics unit through each virtual network interface to the server.

In yet another aspect of the invention, there is provided a system for establishing multipath communication. The system includes a telematics unit configured to establish a connection from the telematics unit to one or more consumer devices, create a virtual network interface in the telematics unit for each of the one or more consumer devices connected to the telematics unit, and transfer packets from the telematics unit through each virtual network interface to the server.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is another exemplary communications system that is capable of utilizing the method disclosed herein; and

FIG. 3 is a flow chart depicting a method for enabling concurrent data streams between the vehicle and the Internet by utilizing one or more consumer devices according to an embodiment of the disclosed invention.

### DETAILED DESCRIPTION OF THE ILLUSTRATED EMBODIMENT(S)

The system and method described below pertain to an overlay architecture that enables the use of an aggregated bandwidth for accelerating Internet/Cloud (hereinafter Internet) content transmission and improving user experience. The architecture enables Internet to end user communication through relay nodes, which provide scalability, robustness and enhanced performance in terms of bandwidth and latency. The architecture builds upon a relatively new multipath transmission control protocol (MPTCP) that splits a connection stream to exploit path diversity. In the method disclosed herein MPTCP enables connectivity between a vehicle telematics unit to consumer device as if the consumer device is part of the telematics unit.

Communications System—

The following detailed description is merely exemplary in nature and is not intended to limit the application and uses. Furthermore, there is no intention to be bound by any expressed or implied theory presented in the preceding technical field, background, brief summary, or the following detailed description.

Referring to the Figures, wherein like numerals indicate like parts throughout the several views, there is shown an operating environment that comprises a mobile vehicle communications system 10 and that can be used to implement the method disclosed herein. While the approach and methodology described below relate to vehicle communications, one of ordinary skill in the art appreciates that an automotive application is merely exemplary, and that the concepts disclosed herein may also be applied to any other suitable communications system, but more specifically, non-vehicle applications. The term vehicle as described herein is also to be construed broadly to include not only a passenger car, but any other vehicle including, but not limited to, motorcycles, trucks, sports utility vehicles (SUVs), recreational vehicles (RVs), marine vessels, and aircraft.

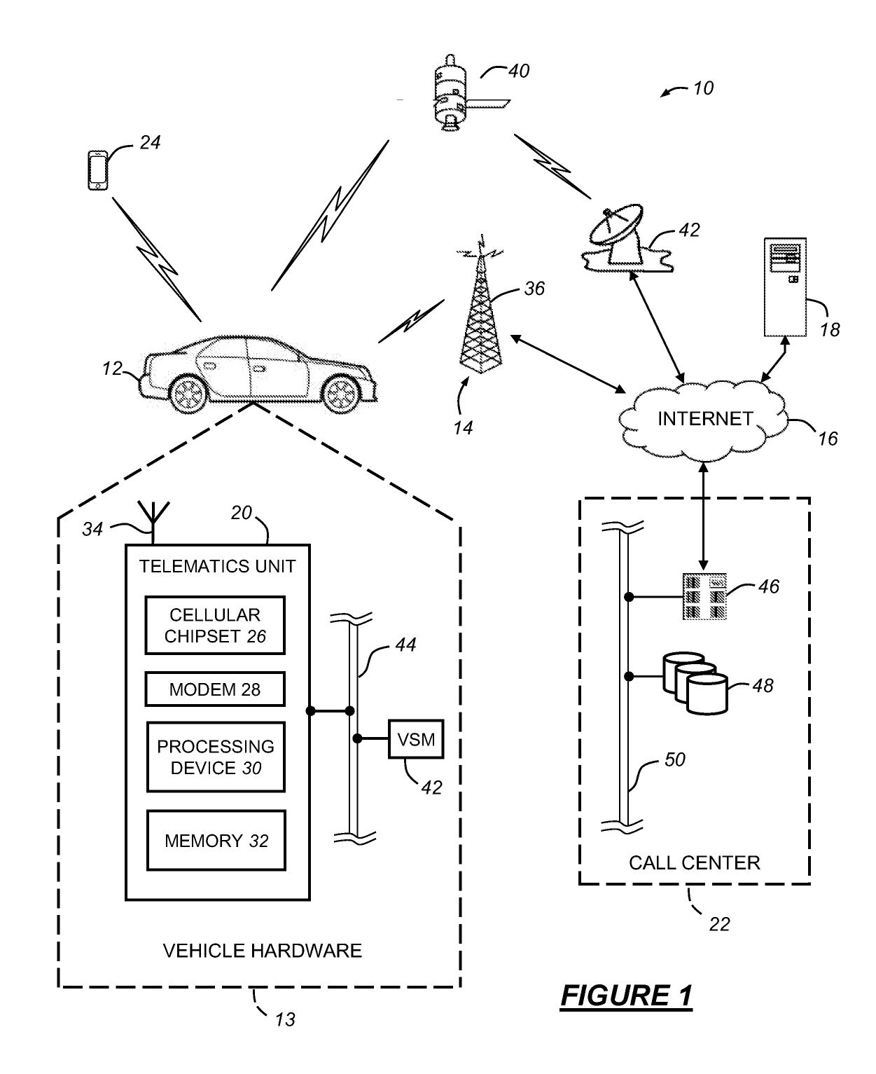

With reference to FIG. 1, there is shown an operating environment that comprises a vehicle communications system 10 that can be used to implement the method disclosed herein. Communications system 10 generally includes a vehicle 12, one or more wireless carrier systems 14, Internet 16, computer 18, and call center 22. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

As shown in FIG. 1, vehicle 12 includes vehicle hardware 13 having a telematics unit 20, which can be an OEM-installed (embedded) or an aftermarket device that is installed in the vehicle and that enables wireless voice and/or data communication over wireless carrier system 14 and via wireless networking This enables the vehicle 12 to communicate with the vehicle call center 22, other telematics-enabled vehicles, or some other entity or device, such as a consumer device 24 or other remote Internet server. In one embodiment the telematics unit 20 uses radio transmissions to establish a communications channel (a voice channel and/or a data channel) with wireless carrier system 14 so that voice and/or data transmissions can be sent and received over the channel. By providing both voice and data communication, telematics unit 20 enables the vehicle 12 to offer a number of different services including those related to navigation, telephony, emergency assistance, diagnostics, infotainment, etc. For example, the telematics unit 20 may include an infotainment module for managing and playing audio content, utilizing navigation for driving, delivering rear-seat entertainment such as movies, games, social networking, listening to incoming and sending outgoing SMS text messages, making phone calls, and accessing Internet-enabled or smartphone-enabled content such as traffic conditions, sports scores, and weather forecasts. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

According to one embodiment, telematics unit 20 utilizes cellular communication according to either GSM, CDMA, or LTE standards and thus includes a standard cellular chipset 26 for voice communications like hands-free calling, a wireless modem 28 for data transmission, an electronic processing device 30, one or more digital memory devices 32 including volatile and non-volatile memory, and a dual antenna 34. It should be appreciated that the modem 28 can either be implemented through software that is stored in the telematics unit 20 and is executed by processor 30, or it can be a separate hardware component located external to telematics unit 20. The modem 28 can operate using any number of different standards or protocols such as LTE, EVDO, CDMA, GPRS, and EDGE. In one embodiment, the modem is a multi-radio access technology (multiRAT) chipset/modem configured to support the wireless networking employed by the disclosed method. Wireless networking between the vehicle and other networked devices (including consumer device 24) can also be carried out using telematics unit 20. For this purpose, telematics unit 20 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit 20 can be configured with a static IP address or can be set up to automatically receive an assigned IP address from another device on the network.

Processor 30 can be any type of device capable of processing electronic instructions including microprocessors, microcontrollers, host processors, controllers, vehicle communication processors, field programmable gate arrays (FPGA), and application specific integrated circuits (ASICs). Processor 30 can be a dedicated processor used only for telematics unit 20 or can be shared with other vehicle systems. Processor 30 executes various types of digitally-stored instructions, such as software or firmware programs stored in memory 32, which enable the telematics unit 20 to provide a wide variety of services. For instance, processor 30 can execute programs or process data to carry out at least a part of the method discussed herein.

Telematics unit 20 can be used to provide a diverse range of vehicle services that involve wireless communication to and/or from the vehicle. Such services include: turn-by-turn directions and other navigation-related services that are provided in conjunction with a GPS-based vehicle navigation module; airbag deployment notification and other emergency or roadside assistance-related services that are provided in connection with one or more collision sensor interface modules such as a body control module (not shown); diagnostic reporting using one or more diagnostic modules; and infotainment- related services where music, webpages, movies, television programs, videogames and/or other information is downloaded by an infotainment module and is stored for current or later playback. The above-listed services are by no means an exhaustive list of all of the capabilities of telematics unit 20, but are simply an enumeration of some of the services that the telematics unit is capable of offering. Furthermore, it should be understood that at least some of the aforementioned modules could be implemented in the form of software instructions saved internal or external to telematics unit 20, they could be hardware components located internal or external to telematics unit 20, or they could be integrated and/or shared with each other or with other systems located throughout the vehicle, to cite but a few possibilities. In the event that the modules are implemented as vehicle system modules 42 located external to telematics unit 20, they could utilize vehicle bus 44 to exchange data and commands with the telematics unit 20.

Wireless carrier system 14 is preferably a cellular telephone system that includes a plurality of cell towers 36 (only one shown) as well as any other networking components required to connect wireless carrier system 14 with Internet 16. Each cell tower 36 includes sending and receiving antennas and a base station. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station arrangements are possible and could be used with wireless system 14. For instance, the base station and cell tower could be co-located at the same site or they could be remotely located from one another, each base station could be responsible for a single cell tower or a single base station could service various cell towers, to name but a few of the possible arrangements.

Apart from using wireless carrier system 14, a different wireless carrier system in the form of satellite communication can be used to provide uni-directional or bi-directional communication with the vehicle. This can be done using one or more communication satellites 40 and an uplink transmitting station 42. Uni-directional communication can be, for example, satellite radio services, wherein programming content (news, music, etc.) is received by transmitting station 42, packaged for upload, and then sent to the satellite 40, which broadcasts the programming to subscribers. Bi-directional communication can be, for example, satellite telephony services using satellite 40 to relay telephone communications between the vehicle 12 and station 42. If used, this satellite telephony can be utilized either in addition to or in lieu of wireless carrier system 14. Additionally, the variety of communications alternatives can reside in licensed or unlicensed bands as well as free of charge or charged systems.

Internet 16 is a global infrastructure of interconnected computer networks to link billions of devices worldwide. Internet 16 is an international network of networks that consists of millions of private, public, academic, business, and government packet switched networks linked by a broad array of electronic, wireless, and optical networking technologies. These computer networks are accessible through the vehicle 12 via telematics unit 20 and wireless carrier system 14 and include, but are not limited to, all servers that host websites, proprietary servers, and DNS servers.

Computer 18 can be one of a number of computers accessible via a private or public network such as the Internet. Each such computer 18 can be used for one or more purposes, such as a web server accessible by the vehicle via telematics unit 20 and wireless carrier system 14. Other such accessible computers 18 can be, for example: a service center computer where diagnostic information and other vehicle data can be uploaded from the vehicle via the telematics unit 20; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 22, or both. A computer 18 can also be used for providing Internet connectivity such as DNS services or as a network address server that uses DHCP or other suitable protocol to assign an IP address to the vehicle 12.

Call center 22 is designed to provide the vehicle hardware 13 with a number of different system back-end functions and, according to the exemplary embodiment shown here, generally includes one or more servers 46 and database(s) 48. These various call center components are preferably coupled to one another via a wired or wireless local area network 50. Data transmissions are passed via the modem to server 46 and/or database 48. Database 48 can store account information such as subscriber authentication information, vehicle identifiers, profile records, behavioral patterns, and other pertinent subscriber information. Data transmissions may also be conducted by wireless systems, such as 802.11x, GPRS, and the like.

The operating environment may further include one or more consumer devices 24. In one embodiment, the consumer device 24 may be an electronic device used to make mobile telephone calls across a wide geographic area where transmissions are facilitated by the wireless carrier system 14 (i.e., when the consumer device 24 is connected to the wireless carrier system 14 through the telematics unit 20). The consumer device 24 may include: hardware, software, and/or firmware enabling cellular telecommunications and communications via short-range wireless communication (e.g., Wi-Fi Direct and Bluetooth) as well as other mobile consumer device applications. Such device applications may include software applications, which may be preinstalled or installed by the user.

The hardware of the consumer device 24 may have electronics known to skilled artisans including a communication interface(s), an antenna, etc. In addition, modern consumer devices 24 may also support additional services and/or functionality such as short messaging service (SMS or texts), multimedia messaging service (MMS), email, internet access, as well as business and gaming applications. Non-limiting examples of the consumer device 24 include a mobile cellular telephone, a personal digital assistant (PDA), a Smart Phone, a tablet, a personal laptop computer having two-way communication capabilities, a netbook computer, or any suitable combinations thereof. In addition, consumer device 24 may also be an aftermarket device dedicated to support the disclosed method. In one embodiment the aftermarket device may serve as a connectivity boost to the vehicle communication systems. The consumer device 24 may be used inside or outside of a vehicle (such as the vehicle 12 shown in FIG. 1), and may be coupled to the vehicle by wire or wirelessly (e.g., using short range wireless communication). The consumer device 24 also may be configured to provide services according to a subscription agreement with a third-party facility or wireless/telephone service provider. It should be appreciated that various service providers may utilize the wireless carrier system 14 and that the service provider of the telematics unit 20 may not necessarily be the same as the service provider of the consumer device 24. The consumer device 24 and the vehicle 12 may be used together by a person known as the vehicle user such as the driver. However, the vehicle user does not need to be the driver of the vehicle 12 nor does the vehicle user need to have ownership of the consumer device 24 or the vehicle 12 (e.g., the vehicle user may be an owner or a licensee of either or both).

The communication between the computer 18, the consumer device 24, and the telematics unit 20 is generally governed by the Transmission Control Protocol/Internet Protocol (TCP/IP), which is the basic communication language or protocol of the Internet 16. TCP/IP is a two-layer program. The higher layer, TCP, manages the assembling of a message or file into smaller packets that are transmitted over the Internet 16 and received by a TCP layer that reassembles the packets into the original message. The lower layer, IP, handles the address part of each packet so that the packet gets to the right destination. Each gateway computer on the network checks this address to see where to forward the message. Even though some packets from the same message are routed differently than others, they'll be reassembled at the destination.

TCP/IP uses the client/server model of communication and is primarily point-to-point, meaning each communication is from one point (or host computer) in the network to another point or host computer. When set up with direct access to the Internet 16 a computing device includes a copy of the TCP/IP program, which provides end-to-end connectivity specifying how data should be packetized, addressed, transmitted, routed, and received at the destination. This functionality is organized into four abstraction layers that are used to sort all related protocols according to the scope of networking involved. From lowest to highest, the layers are the link layer, which contains communication technologies for a single network segment (link); the Internet layer, which connects hosts across independent networks; the transport layer handling host-to-host communication; and the application layer, which provides process-to-process application data exchange.

TCP accepts data from a data stream, divides it into chunks, and adds a TCP header creating a TCP segment. The TCP segment is then encapsulated into an IP datagram, and exchanged with peers. A TCP segment consists of a segment header and a data section. The TCP header contains ten mandatory fields, and an optional extension field. Included in the TCP header are synchronous and acknowledge messages indicated by a SYN bit and ACK bit, respectively. To initiate a TCP/IP connection, a three-way handshake is used between a local host/client and a server to create a TCP socket connection. Essentially, a client node sends a SYN data packet over an IP network to a server on the same or an external network. The objective of this packet is to ask/infer if the server is open for new connection. When the server receives the SYN packet from the client node, it responds and returns a confirmation receipt—the ACK packet or SYN/ACK packet. The client node receives the SYN/ACK from the server and responds with an ACK packet.

As set forth above, TCP/IP provides for a singular end-to-end connection between hosts (e.g., a client and a server). While packets that are being transmitted using TCP/IP may take multiple routes to the destination through routers, there nonetheless remains only a single connection between the two hosts. Another protocol, Multipath TCP (MPTCP), is an extension of TCP developed as part of the TCP/IP stack and adds the capability of using multiple paths to a regular TCP session. MPTCP is a transport layer protocol that targets devices with multiple modems and supports multiple communication lines between two endpoints while preserving the appearance of a single TCP socket at both end side applications. MPTCP initiates a session similar to a TCP connection, except that the SYN message in the header contains an MP_Capable flag, which requests that the other side open an MPTCP connection. In this way, the server is notified that the client supports an MPTCP session. If the server also supports MPTCP, the two sides coordinate through the three-way handshake and create a unique session token or connection ID. To fully utilize the bandwidth, the client opens additional TCP connections to the server, adding to the first TCP connection. These additional connections are referred to as subflows, which are created from the client's additional network cards and initiated using an MPTCP SYN message that carries the session token. The session token enables the server to link a subflow connection to the session with the corresponding session token. MPTCP balances the load between the communication lines participating in the communication.

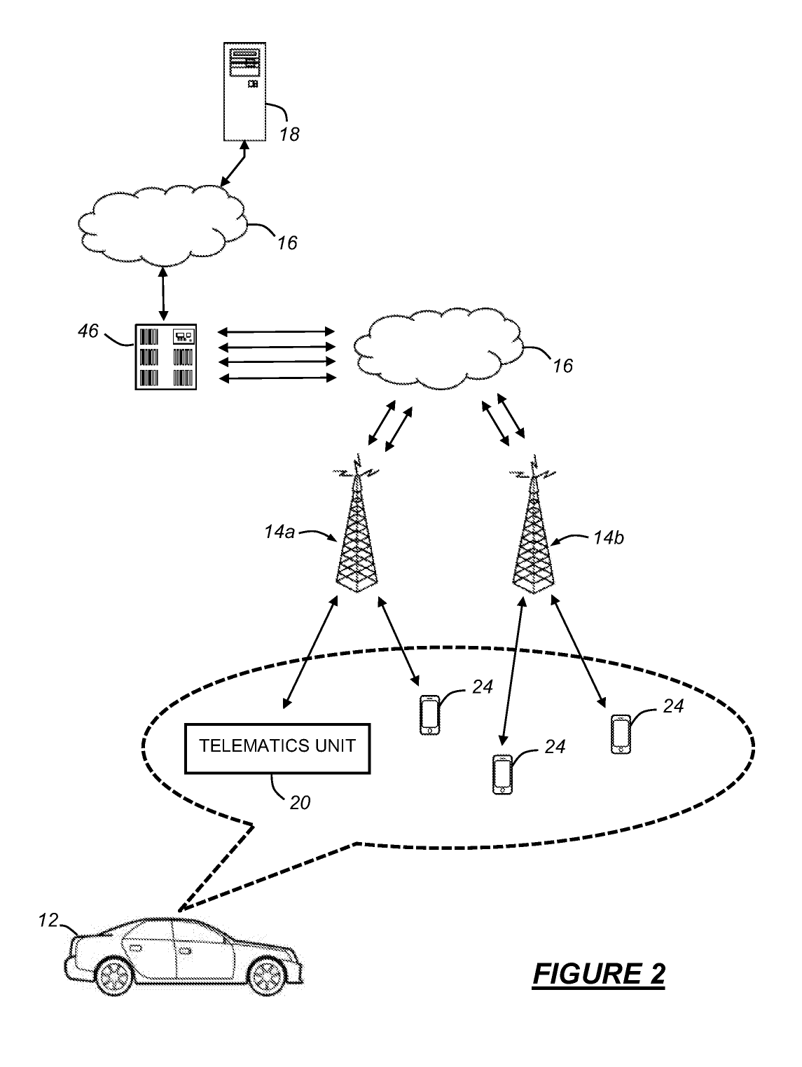

FIG. 2 illustrates a particular embodiment of the communications system shown in FIG. 1 that is capable of utilizing the method disclosed herein. More specifically, FIG. 2 illustrates an exemplary implementation of the disclosed method, which builds on the MPTCP platform. The method, discussed in detail below, and the architecture shown in FIG. 2, enables end user to cloud server communication through relay nodes providing scalability, robustness, and enhanced performance in terms of bandwidth and latency. The system is an overlay architecture that enables the user of an aggregated bandwidth for accelerating cloud content transmission and thus improving user experience.

As set forth above, MPTCP exploits path diversity by splitting a connection stream when there is more than one network card at the source with access to a server. The present method utilizes a variety of consumer devices 24, each of which has its own Internet access, as extended virtual network interface cards (Virtual NICs) within the session initiator. In this way, the consumer devices serve as relay nodes for data transfer. In short, the method uses MPTCP to split the data traffic, encapsulates the MPTCP subflows into a user datagram packet (UDP) packet and tunnels the subflows through virtual network cards over the vehicle network to the consumer devices 24 serving as relays. The consumer devices 24 in turn further tunnel the subflow over their own dedicated link all the way to the cloud server, which in one embodiment is server 46. The tunneled subflows are captured by server 46 and redirected. One of ordinary skill in the art understands that the “packet” is not limited to the transfer of data, but rather includes any payload that can be conveyed over TCP.

In one embodiment, the telematics unit 20 (i.e., the client) configures a virtual NIC for each consumer device 24 that connects to the telematics units 20 as an access point and associates each consumer device 24 with a MPTCP subchannel as an MPTCP encapsulated subflow. This process takes place in two parts. First, upon connection of the consumer device 24 to the telematics unit 20, the telematics unit 20 creates a virtual NIC for each device 24. An MPTCP subchannel is then created for each consumer device 24 with the server 46. That is, the telematics unit 20 associates each consumer device 24 with its corresponding virtual NIC, created upon connection of the consumer device 24 to the access point. In other words, each virtual NIC is a subchannel in the MPTCP session. Each MPTCP subchannel packet is encapsulated in a user datagram protocol (UDP) packet destined to the corresponding consumer device 24. Encapsulation of the packet is done at both the client and server ends of the communication.

In one embodiment, an application in the consumer device 24 performs the UDP tunneling as the consumer device 24 receives the UDP packets over the virtual NIC and replaces the UDP header with the communication endpoint IP address and thereafter sends the packets over a second communications card in the consumer device 24. For upload, the UDP packet is received over a network interface (e.g., WiFi interface) and is rerouted over the cellular interface to the server 46. For a download, the UDP packet is received over the cellular interface and the packet is rerouted over the network interface to the telematics unit 20. At both the client and server end of the communication, the receiving end captures the UDP packet, removes the header, and passes the embedded MPTCP packet to the corresponding MPTCP subchannel. Alternatively, in lieu of an application, one of ordinary skill in the art understands that this functionality may become part of a kernel if adopted by an operating system. There may also be an implementation where there is a combination of a user application (for setting parameters, etc.) and an operating system kernel configured to perform the tunneling and IP forwarding functionality.

Method—

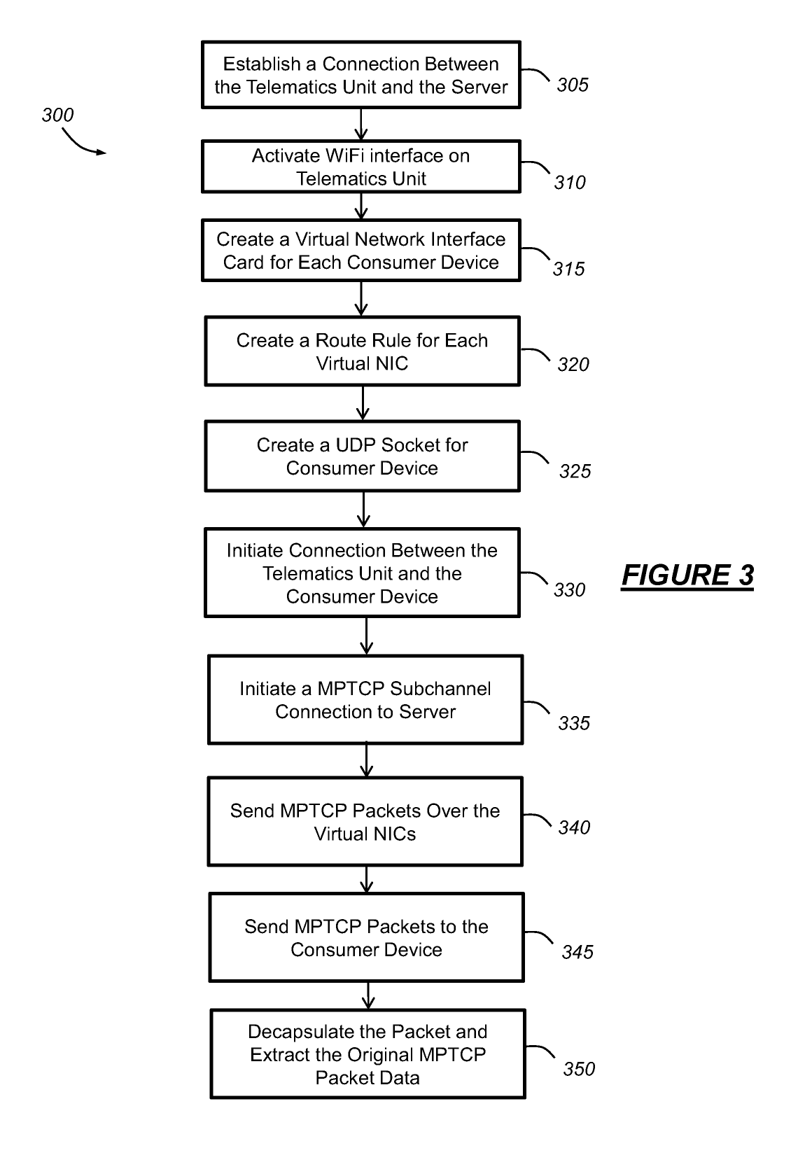

Turning now to FIG. 3, there is a method 300 for enabling multiple data streams between two endpoints using relay nodes according to the following exemplary embodiment. The method 300 begins at step 305 with telematics unit 20 establishing a persistent connection to the server 46. One of ordinary skill in the art recognizes that the method described herein connects the telematics unit 20 to server 46, which is part of call center 22. However, it is understood that server 46 is merely exemplary and connection may be established to other servers outside of call center 22 and remain within the scope of the disclosed method. In addition, one of ordinary skill in the art understands that step 305 may be optional in that no direct link between the client (e.g., telematics unit) and the server is necessary to perform the disclosed method.

At step 310 the telematics unit activates its WiFi interface, becoming an access point that awaits connection by consumer devices 24. Once the telematics unit 20 is activated, each consumer device 24 can connect to it, and the telematics unit 20 at step 315 will create and associate a virtual NIC for each consumer device 24. In one embodiment the connection between the consumer device and the telematics unit 20 is made via a secure short-range wireless communication. The telematics unit 20 and the consumer device 24 can communicate with each other via any suitable short-range wireless communication technology using a standardized protocol, such as Bluetooth or others, some of which have been listed above. In one non-limiting example, the consumer device 24 and the vehicle telematics unit 20, acting here as a wireless access point, utilize the association and authentication process set forth in IEEE 802.11 to establish connectivity. In brief, the consumer device 24 and the telematics unit 20 exchange a series of management frames in order to get to an authenticated and associated state between the consumer device 24 and the telematics unit 20.

In another embodiment, the telematics unit 20 may also be linked or paired to a software application (“app”) installed on the consumer device 24. After an initial linking or pairing to the telematics unit 20, the app on the consumer device 24 may automatically communicate with the telematics unit 20 through any suitable wireless communications technology as set forth above, or there may be an authentication mechanism such as requiring a password or other identifying information prior to connection with the telematics unit 20.

Referring back to the creation of the virtual NIC in step 315, each virtual NIC is configured with an IP address and media access control (MAC) address, which is an identifier assigned to network interfaces for communications on the physical network segment. At step 320 a route rule is created for each virtual NIC. The route rule enables the operating system of the telematics unit 20 to use the virtual NIC and to trigger the MPTCP to take action. In one embodiment the routing rules are in the form of tables, which enable the creation of the subchannels. At step 325, a UDP socket is created on the telematics unit 20 for communication with the virtual NIC for each consumer device 24.

Once the consumer devices 24 in or near the vehicle 12 are connected to the telematics unit 20, at step 330 a first connection is initiated between the telematics unit 20 and the consumer device 24 over the UDP socket. Then, a handshake is performed between the telematics unit 20 and the server 46. The consumer device 24 simply relays handshake packets generated by the telematics unit 20 over the MPTCP implementation proposed herein. Acting as a relay, the consumer device 24 doesn't have to implement its own MPTCP stack for the handshake to take place. The MPTCP communication disclosed by the present method may also be implemented using a software application.

At step 335 a MPTCP connection to server 46 is initiated and the telematics unit 20 creates a MPTCP subchannel for each consumer device 24 to the server 46. By default, MPTCP will utilize all possible NICs including virtual NICs. At step 340, MPTCP packets are sent over the virtual NICs. Meanwhile, telematics unit 20 waits for packets from each virtual NIC. When the packets arrive, they are encapsulated such that the entire packet, including the headers, is encapsulated and conveyed as the data of another packet. However, in some cases the encapsulation may not include the entire packet, only TCP headers, TCP options, and TCP data. At step 345 the encapsulated packet is sent over the local area network interface to the consumer device 24 over the UDP socket. The consumer device 24 receives and transmits the encapsulated packet to the server 46.

In one embodiment, the packet encapsulation has a multistep approach. For instance, the packets are encapsulated at the source, which in this particular example is the telematics unit 20, sent over the WiFi interface to the consumer device 24. Since the consumer device 24 is generally not configured to include routing capabilities, the consumer device 24 decapsulates the MPTCP subflow packet and then encapsulates the packet again, this time with the destination server address and port. The encapsulated packet is then sent over the cellular network to the server 46. This example is particular to an upload scenario, but is equally applicable to a download scenario.

At step 350 the server 46 decapsulates the packet by removing the first header and extracting the original MPTCP packet data, which is conveyed to the MPTCP stack. One of ordinary skill in the art appreciates that the method described above relates to an upload scenario. The download scenario is similar and differs only in that the server 46 is now constructing the MPTCP packets, encapsulating them and sending them to the consumer devices 24. The devices 24 then relay the packets to the vehicle 12.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method for establishing a multipath connection between two endpoints, the method comprising the steps of:
establishing a connection between a first of the two endpoints and one or more consumer devices;
creating a virtual network interface in the first of the two endpoints for each of the one or more consumer devices connected to the first of the two endpoints; and
transferring packets from the first of the two endpoints through each virtual network interface to a second of the two endpoints.

2. The method of claim 1, further including creating a MPTCP subchannel for each virtual network interface.

3. The method of claim 2, wherein each of the one or more consumer devices serves as a relay node for transferring the packets between the two endpoints.

4. The method of claim 1, further including creating a MPTCP connection between the two endpoints, wherein each of the virtual network interfaces is MPTCP subchannel.

5. The method of claim 4, further including encapsulating each packet transmitted on the MPTCP subchannel such that the data packet is encapsulated and conveyed between the two endpoints as the data of another packet.

6. The method of claim 5, wherein each packet transmitted on the MPTCP subchannel is encapulsulated in a UDP packet.

7. The method of claim 5, wherein the packets are encapsulated at the first of the two endpoints and decapsulated at the second of the two endpoints.

8. The method of claim 5, wherein the packets are encapsulated at the second of the two endpoints and decapsulated at the first of the two endpoints.

9. The method of claim 1, wherein the first of the two endpoints is a vehicle telematics unit and the second of the two endpoints is a cloud server.

10. The method of claim 9, wherein the cloud server is a call center server.

11. The method of claim 1, wherein the consumer device is a mobile phone.

12. The method of claim 1, wherein the consumer device is a dedicated aftermarket device.

13. The method of claim 1, further including creating a route rule to govern the transfer of packets through each virtual network interface to a second of the two endpoints.

14. A method for enabling multiple connections between a vehicle telematics unit and a server using MPTCP, the method comprising the steps of:
establishing a connection from the vehicle telematics unit to one or more consumer devices;
creating a virtual network interface in the telematics unit for each of the one or more consumer devices connected to the telematics unit; and
transferring packets from the telematics unit through each virtual network interface to the server.

15. The method of claim 14, further including creating a MPTCP subchannel for each virtual network interface.

16. The method of claim 14, wherein each of the one or more consumer devices serves as a relay node for transferring the packets between the vehicle telematics unit and the server.

17. The method of claim 14, further including encapsulating each packet transmitted on a MPTCP subchannel such that the packet is encapsulated and conveyed between the vehicle telematics unit and the server as the data of another packet.

18. The method of claim 17, wherein the packets are encapsulated at the telematics unit and decapsulated at the server, or alternatively, encapsulated at the server and decapsulated at the telematics unit.

19. The method of claim 17, wherein each data packet transmitted on the MPTCP subchannel is encapulsulated in a UDP packet.

20. A system for establishing multipath communication, the system comprising:
a telematics unit configured to:
establish a connection from the telematics unit to one or more consumer devices;
create a virtual network interface in the telematics unit for each of the one or more consumer devices connected to the telematics unit; and
transfer packets from the telematics unit through each virtual network interface to a server.
